(19) United States
(12) Patent Application Publication
(10) Pub. No.: US 2006/0165963 A1
(43) Pub. Date: Jul. 27, 2006

(54) Transparent substrate comprising antiglare coating

(75) Inventors: Carinne Fleury, Paris (FR); Thibaut Heitz, Lyon (FR); Nicolas Nadaud, Gentilly (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, COURBEVOIE (FR)

(21) Appl. No.: 10/519,098

(22) PCT Filed: Jul. 2, 2003
(86) PCT No.: PCT/FR03/02052

§ 371 Date: Jan. 20, 2006

(30) Foreign Application Priority Data
Jul. 3, 2002 (FR) 02/08290

(51) Int. Cl. B32B 7/02

(52) U.S. Cl. 428/212

(57) ABSTRACT

A transparent substrate (6), comprising on at least one of its faces an antireflection coating, particularly at normal incidence made of a multilayer (A) of thin layers, characterized in that the multilayer comprises, in succession:
a first layer (1), with a refractive index n₁ of between 1.8 and 2.2 and geometrical thickness e₁ of between 5 and 50 nm,
a second layer (2), with a refractive index n₂ of between 1.35 and 1.65 and a geometrical thickness e₂ of between 5 and 50 nm,
a third layer (3) with a refractive index n₃ of between 1.8 and 2.2 and a geometrical thickness e₃ of between 40 and 150 nm,
a fourth layer (4) with a refractive index n₄ of between 1.35 and 1.65 and a geometrical thickness e₄ of between 40 and 150 nm,

The invention relates to a transparent substrate, particularly made of glass, intended to be incorporated into glazing and equipped, on at least one of its faces, with an antireflection coating.

An antireflection coating usually consists of a multilayer made up of interferential thin layers, generally alternation of dielectric-based layers with high and low refractive indexes. Deposited on a transparent substrate, such a coating has the function of reducing its light reflection, and therefore of increasing its light transmission. A substrate thus coated therefore sees an increase in its transmitted light/reflected light ratio, thus improving the view of objects placed behind it. When efforts are made to achieve a maximum antireflection effect, it is therefore preferable to equip both faces of the substrate with this type of coating.

This type of product has many applications: it can be used as glazing in buildings, or as glazing in shop furniture, for example as a display cabinet in a store and as architectural curved glass, so as to give a better view of the goods on display even when the lighting inside is low by comparison with the outside. illumination. It may also act as sales counter glass.

Examples of antireflection coatings are described in patents EP 0 728 712 and WO97/43224.

Most antireflection coatings developed to date have been optimized to minimize the light reflection at normal incidence, without taking account of the optical aspect and esthetic appearance of the glazing viewed obliquely, the mechanical durability of the multilayer and the ability of the product to stand up to heat treatment. It is thus known that, at normal incidence, it is possible to obtain very low light reflection values R_{L} with four-layer multilayers comprising a high-index layer/low-index layer/high-index layer/low-index layer alternation. The high-index layers are generally made of TiO₂ which actually has a very high index of about 2.45 and the low-index layers are usually made of SiO₂. The optical thicknesses of the layers (the product of their geometrical thickness times their refractive index) are expressed in succession as follows: (e1+e2)<λ4−e3≧λ/2−e4=λ/4, where λ is the wavelength averaged over the visible range around 500 nm and e1 to e4 are the thicknesses of the four layers deposited in succession on the substrate.

The appearance in reflection, particularly the intensity of the light reflection is not, however, satisfactory once the view through the glazing diverges a little from the perpendicular. The mechanical resistance and thermomechanical withstand of this type of multilayer are also unsatisfactory.

Studies have been conducted to take account of an oblique viewing angle, but these have not yielded full satisfaction: Mention may for example be made of patent EP-0 515 847 which proposes a two-layer multilayer of the TiO₂+SiO₂/SiO₂ type or a three-layer multilayer of the TiO₂+SiO₂/TiO₂/SiO₂ deposited by the sol-gel technique, but which does not give adequate performance. This deposition technique also has the disadvantage of producing multilayers of low mechanical resistance.

It is therefore an object of the invention to remedy the above disadvantages by seeking to develop an antireflection coating which simultaneously guarantees good esthetic appearance of the glazing regardless of the angle of incidence, particularly at 0°, good mechanical durability and a good ability to withstand heat treatment (annealing, toughening, curving, bending) and also without compromising the economic and/or industrial feasibility of its manufacture.

The subject of the invention first of all is a transparent substrate, particularly made of glass, comprising on at least one of its faces an antireflection coating of thin layers made of dielectrical material with alternatively high and low refractive indexes, particularly having an antireflection effect at normal incidence, and defined as follows. It comprises, in succession:

a high-index first layer 1, with a refractive index n₁ of between 1.8 and 2.3 and geometrical thickness e₁ of between 5 and 50 nm,

a low-index second layer 2, with a refractive index n₂ of between 1.35 and 1.65 and a geometrical thickness e₂ of between 5 and 50 nm,

a high-index third layer 3 with a refractive index n₃ of between 1.8 and 2.3 and a geometrical thickness e₃ of between 40 and 150 nm,

a low-index fourth layer 4 with a refractive index n₄ of between 1.35 and 1.65 and a geometrical thickness e₄ of between 40 and 125 nm,

this multilayer being designed on the one hand to guarantee the substrate a good esthetic appearance irrespective of the angle of incidence and, being able on the other hand to undergo heat treatment.

Within the meaning of the invention, a “layer” is to be understood as meaning either a single layer or a superposition of layers in which each of the layers has the refractive index given and in which the sum of their geometrical thicknesses also observes the value given for the layer in question.

Within the meaning of the invention, the layers are made of dielectric material, particularly of the metal oxide, nitride or oxynitride type, as will be detailed later. However, this does not exclude at least one of these layers being modified so that it is at least slightly conducting, for example by doping it with a metal oxide, this being done for example in order to give the antireflection multilayer an antistatic function also.

The invention is preferably concerned with glass substrates, but also applies to transparent substrates based on polymer, for example made of polycarbonate.

The invention therefore relates to an antireflection multilayer with at least one sequence of four layers in which layers with high and low refractive indexes are alternated.

The thickness and refractive index criteria adopted in the invention make it possible to obtain a broadband low light reflection antireflection effect with a neutral color in transmission and good esthetic appearance in reflection, and to do so regardless of the angle of incidence from which the substrate thus coated is observed.

Selecting these criteria has been a tricky process because the inventors gave consideration to the industrial feasibility of the product and to the appearance in light reflection at two levels: both with a wish to minimize the value of light reflection RL at normal incidence in itself, and also in wishing to obtain satisfactory colorimetry for oblique light reflection, that is to say color in reflection the shade and intensity of which were acceptable from an esthetic standpoint, and to do so without compromising the properties of the multilayer with regard to mechanical durability and resistance to heat treatment.

The inventors achieved this, with, in particular, a reduction by at least 3 or 4% of the value of RL in the visible, and obtaining b* values in the (L, a*, b*) colorimetry system which are negative for this same light reflection. This results in a significant reduction in reflections and a green, blue or violet color in reflection (avoiding the yellowish appearance) which is currently deemed esthetically acceptable in numerous applications, particularly in the field of building. The inventors also contrived for these same multilayers to have resistance to abrasion such that the haze caused by a TABER test does not exceed 3% and resistance to heat treatment such that the product can be toughened or curved to radii of curvature in excess of 1 meter and even, in certain cases, to radii of curvature of the order of 10 cm.

The principle of operation of an apparatus for performing a TABER test is recalled hereinbelow.

Two abrasive grinding wheels loaded to 250 g rest on a test specimen positioned horizontally on a turntable. A greater bearing load (up to a total of 1 kg) can be set according to the test. As the test specimen rotates, the grinding wheels turn in opposite directions on a 30 cm², annulus, and do so twice for each rotation.

The abrasion-resistance test is performed in three stages:

stage of cleaning the grinding wheels

actually abrading the test specimen

measuring the haze caused by this abrasion

As far as the cleaning state is concerned, this consists in positioning in turn in the place of the test specimen

an abrasive (25 revolutions)

a bare float glass (100 revolutions)

The abrasion stage is performed on a test specimen measuring 10 cm×10 cm The haze is measured using a BYK Gardner XL-211 turbidimeter. This apparatus is used to measure the haze on the impression left by the TABER test grinding wheel during abrasion, in the following way:

ΔH=(Total transmission of the test specimen/Transmission diffused by the test specimen)×100

For the application at which this patent application is aimed, use is made of the following operating conditions: grinding wheel: CS 10 F; load 500 g; 650 revolutions.

The two most outstanding characteristics of the invention are as follows: it has been discovered that, unlike the choice usually made for high-index layers, there was no need, and it was even disadvantageous, to choose materials with a very high index such as TiO₂. It was found that it was, by contrast, more sensible to use for these layers materials with a more modest refractive index, particularly those with an index of 2.2 at most. This therefore goes against the known teaching for antireflection multilayers in general. It was thus demonstrated that materials with indexes of around 2.0 made it possible to obtain good antireflection coatings with optical properties (light reflection at 0°) comparable with those obtained using materials the refractive index of which is somewhere around 2.45 (TiO₂ for example).

it was also demonstrated that the use of materials with a more modest refractive index such as SnO₂, Si₃N₄, SnₓZn_{y}O_{z}, TiZnOₓ or SiₓTi_{y}O_{z} made it possible to significantly improve the mechanical resistance properties (resistance to abrasion, scratching, to cleaning) and properties of resistance to heat treatment (annealing, toughening, curving) of the multilayers.

The inventors thus exploited the fact that, at an oblique incidence, the low reflection spectrum was broadened, and that it was thus possible to sanction the use of materials with an index of around 2, such as tin oxide SnO₂, silicon nitride Si₃N₄, mixed tin-zinc oxides SnₓZn_{y}O_{z}, mixed zinc-titanium oxides TiZnOₓ or silicon-titanium oxides SiₓTi_{y}O_{z}. By comparison with TiO₂ in particular, these materials, in addition to having better mechanical properties, have the advantage of having far higher deposition rates when use is made of the deposition technique known as cathode sputtering. In this modest range of indexes, there is also a wider choice of materials that can be deposited by cathode sputtering, thus offering greater flexibility in industrial manufacture and more options for adding additional functionalities to the multilayer as will be detailed hereinbelow.

The preferred ranges for the geometrical thicknesses and indexes of the four layers of the multilayer according to the invention are given hereinbelow, this multilayer being termed A:

n₁ and/or n₃ are between 1.85 and 2.15, particularly between 1.90 and 2.10.

n₂ and/or n₄ are between 1.35 and 1.65.

e₁ is between 5 and 50 nm, particularly between 10 and 30 nm or between 15 and 25 nm.

e₂ is between 5 and 50 nm, particularly less than or equal to 35 nm or to 30 nm, particularly being between 10 and 35 nm.

e₃ is between 40 and 120nm and preferably between 45 and 80 nm.

e₄ is between 45 and 110 nm and preferably between 70 and 100 nm.

According to an alternative form of the invention, the high-index first layer 1 and the low-index second layer 2 can be replaced with a single layer 5 with an “intermediate” refractive index e₅, in particular of between 1.65 and 1.80 and preferably having an optical thickness e_{.opt5} of between 50 and 140 nm, preferably between 85 and 120 nm. In conventional 3-layer antireflection multilayers, which are optimized to be viewed perpendicularly, this thickness is somewhat above 120 nm. This intermediate-index layer has an optical effect similar to that of a high-index layer/low-index layer sequence, as far as the first sequence is concerned, of the two layers closest to the substrate bearing the multilayer. It has the advantage of reducing the overall number of layers in the multilayer. It is preferably based on a mixture of, on the one had, silicon oxide and, on the other hand, at least one metal oxide chosen from tin oxide, zinc oxide, titanium oxide. It may also be based on a silicon oxynitride or oxycarbide and/or aluminum oxytride.

The most appropriate materials from which to make the first and/or third layer of the multilayer A, those with a high index, are based on (a) metal oxide(s) chosen from zinc oxide (ZnO), tin oxide (SnO₂), zirconium oxide (ZrO₂), mixed tin-zinc oxides (SnₓZn_{y}O_{z}), mixed zinc-titanium oxides (TiZnOₓ), or silicon-titanium oxides (SiₓTi_{y}O_{z}.). They may also be based on (a) nitride(s) chosen from silicon nitride (Si₃N₄) and/or aluminum nitride (AlN). All these materials may possibly be doped to improve their chemical and/or mechanical and/or electrical resistance properties.

The most appropriate materials from which to make the second and/or fourth layer of the multilayer A, those with a low index, are based on silicon oxide, silicon oxynitride and/or oxycarbide or alternatively based on a mixed oxide of silicon and of aluminum. Such a mixed oxide tends to have better durability, particularly chemical durability, than pure SiO₂ (an example of this is given in patent EP-791 562). The respective proportion of the two oxides can be adjusted in order to obtain the desired improvement in durability without excessively increasing the refractive index of the layer.

Thus, the substrates incorporating such layers in their multilayer can, without damage, undergo heat treatment such as annealing, toughening, curving or even bending. These heat treatments must not adversely affect the optical properties and this functionality is important for glazing the counters in stores because this is glazing that has to undergo high temperature heat treatment of the curving, toughening, annealing, laminating type, where the glass has to be heated to at least 120° C. (in the case of lamination) or up to 500 à 700° C. (for curving or toughening). The fact of being able to deposit the thin layers before heat treatment without that posing any problem (depositing layers onto a curved glass is tricky and expensive; it is far simpler from an industrial viewpoint to perform deposition before any heat treatment) then becomes of decisive benefit.

The curving may be done with a small radius of curvature (of the order of 1 m) or even with a very small radius of curvature (of the order of 10 centimeters or so), typically for an application relating to displays for goods, counters in stores in particular.

It will be noted that, by comparison with multilayers of the prior art, the multilayer according to the invention, and particularly the SiO₂/Si₃N₄ association, has the advantage of being stable to heat treatment, of allowing curving at small radii of curvature (R=1 m approximately), and likewise the SiO₂/mixed tin-zinc or silicon/titanium oxides association guarantees curvatures or even bendings at very small radii of curvature (R=10 cm approximately). Furthermore, these two associations, which are the subject of the prevent invention, guarantee improved chemical and mechanical durability, and in any case mechanical and chemical durabilities superior to those obtained with a multilayer containing TiO₂. Indeed, no multilayer of the prior art is able to obtain both good mechanical and chemical durability properties and the ability to undergo curving and/or bending operations without exhibiting major optical defects.

It is thus possible to have a single antireflection multilayer configuration regardless as to whether or not the carrier glass is intended to undergo heat treatment. Even if it is not intended to be heated, it remains advantageous to use at least one nitride layer because this improves the mechanical and chemical durability of the multilayer as a whole.

According to one particular embodiment, the first and/or third layer, those with the high index, may in fact be made up of several superposed high-index layers. These may quite particularly consist of a bilayer of the SnO₂/Si₃N₄ or Si₃N₄/SnO₂ type. The advantage of this is as follows: Si₃N₄ tends to be deposited a little less readily, a little more slowly than a conventional metal oxide such as SnO₂, ZnO or ZrO₂ by a reactive sputtering. In the case of the third layer in particular, which is the thicker one and the one which is most important for protecting the multilayer from any damage that may result from heat treatment, it may be advantageous to split the layer so as to deposit just enough thickness of Si₃N₄ to obtain the effect of protection against the desired heat treatment and to optically “make up” the layer using SnO₂ or ZnO.

The glass chosen for the substrate coated with the multilayer A according to the invention or for the other substrates associated with it to form a glazed unit, may in particular be, for example, ultraclear of the “Diamant” type, or clear of the “Planilux” type or tinted of the “Parsol” type, these being three products marketed by Saint-Gobain Vitrage, or alternatively may be of the “TSA” or “TSA++” type as described in patent EP 616 883. It may also be glass possibly tinted as described in patents WO 94/14716; WO 96/00194, EP 0 644 164 or WO 96/28394. It may filter radiation of the ultraviolet type.

Another subject of the invention is glazed units incorporating the substrates equipped with the multilayer A defined above. The glazing in question may be “monolithic”, that is to say made up of a single substrate coated with the multilayer on one of its faces. Its opposite face may be devoid of any antireflection coating, being bare or covered with another coating B that has another functionality. This may be a coating with a solar protection function (using, for example, one or more layers of silver surrounded by layers of dielectric, or layers of nitride such as TiN or ZrN or metal oxides or a steel or an Ni—Cr alloy), with a low-emissivity function (for example made of doped metal oxide such as F:SnO₂ or tin-doped indium oxide ITO or one or more layers of silver), with an antistatic function (oxygen-doped or oxygen-substoichiometric metal oxide), heating layer (doped metal oxide, Cu, Ag for example) or an array of heating wires (copper wires or bands screen-printed from a conducting silver slurry), an antifogging function (using a hydrophilic layer), an antirain function (using a hydrophobic layer, for example based on fluoropolymer), antifouling function (photocatalytic coating containing TiO₂ at least partially crystallized in anatase form).

Said opposite face may also be equipped with an antireflection multilayer to maximize the sought-after antireflection effect. In this case, either this is also an antireflection multilayer meeting the criteria of the present invention, or it is some other type of antireflection coating.

Another advantageous glazed unit incorporating a substrate coated according to the invention has a laminated structure combining two glass substrates using one or more sheets of thermoplastic such as polyvinyl butyral PVB. In this case, one of the substrates is equipped, on the outer face (facing away from the assembly of the glass with the thermoplastic sheet) with the antireflection multilayer according to the invention. The other glass pane, on the outer face also, may, as before, be bare, coated with layers with another functionality, coated with the same antireflection multilayer or with another type (B) of antireflection multilayer, or alternatively with a coating which has some other functionality as in this instance (this other coating may also be arranged not on a face facing away from the assembly, but on one of the faces of one of the rigid substrates which faces toward the thermoplastic sheet used for assembly). It is thus possible to equip the laminated glazing with an array of heating wires, with a heating layer, or with a solar-protection coating “within” the laminate.

The invention also comprises glazed units equipped with the antireflection multilayer of the invention and which are multiple glazed units, that is to say ones using at least two substrates separated by an intermediate layer of gas (double or triple glazing). Here again, the other faces of the glazing may also be antireflection treated or may have some other functionality.

Note that this other functionality may also consist in arranging on one and the same face the antireflection multilayer and the multilayer that has another functionality (for example, topping the antireflection coating with a very fine layer of antifouling coating), the addition of this additional functionality of course not being done to the detriment of the optical properties.

Another subject of the invention is the method for manufacturing glass substrates with an antireflection coating according to the invention. One method consists in depositing all the layers, in succession one after another, using a vacuum technique, particularly by magnetically-enhanced cathode sputtering or by corona discharge. Thus, the layers of oxide can be deposited by reactive sputtering of the metal in question in the presence of oxygen, and the nitride layers can be deposited in the presence of nitrogen. To produce SiO₂ or Si₃N₄, the starting point may be a silicon target lightly doped with a metal such as aluminum to make it sufficiently conducting.

Another subject of the invention is applications of these glazings, most of which applications have already been mentioned: shop windows, display cabinets, counters in stores, glazing for buildings, for any display device such as computer screens, televisions, any glass furniture, any decorative glass, car roofs. These glazings may be curved/toughened after the layers have been deposited.

The advantageous characteristics and details of the invention will now become apparent from the nonlimiting examples which follow, with the aid of the figures:

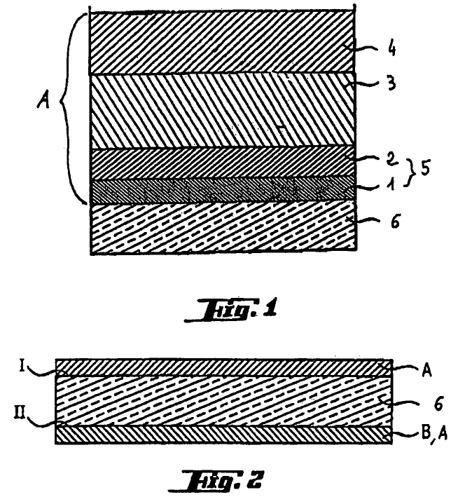

FIG. 1 is a substrate equipped on one of its two faces with a four-layer antireflection multilayer according to the invention

FIG. 2 is a substrate equipped on each of its faces with a four-layer antireflection multilayer according to the invention.

All the examples 1 to 4 relate to four-layer antireflection multilayers. The layers were all deposited in a conventional way by magnetically-enhanced cathode sputtering and reactive sputtering under an oxidizing atmosphere from an Si or metal target in order to produce layers of SiO₂ or of metal oxide, from an Si or metal target under a nitriding atmosphere to produce nitrides, and in a mixed oxidizing/nitriding atmosphere in order to produce the oxynitrides. The Si targets may contain another metal in a small quantity, particularly Zr, Al, particularly to make them more conducting.

For examples 1 to 4, the antireflection multilayer used is as follows:

(6): glass

(1): Si₃N₄ index n1=2

(2): SiO₂ index n2=1.46

(3): Si₃N₄ index n3=2

(4): SiO₂ index n4=1.46

### EXAMPLE 1

This is glass 6 of FIG. 1. The glass is a clear soda-lime-silicate glass 4 mm thick, marketed under the name of Planilux by Saint-Gobain Vitrage.

This glass consists of monolithic glazing and is equipped in both faces with the antireflection multilayer.

The table below summarizes the index nᵢ and geometrical thickness eᵢ in nanometers of each of the layers:

| EXAMPLE 1 | LAYER (1) | | LAYER (2) | | LAYER (3) | | LAYER(4) | |
|---|---|---|---|---|---|---|---|---|
| nᵢ | 2.0 | | 1.46 | | 2.0 | | 1.46 | |
| Eᵢ | 35 | nm | 19 | nm | 50 | nm | 90 | nm |

This multilayer is particularly suited to an application in the building trade, for which the color in transmission is neutral (close to gray), the light reflection is very much lower than 2% and advantageously lower than 1%, the values of a*, b* are respectively 3 and −10, and the color in reflection at 0° incidence is blue.

### EXAMPLE 2

This is glass 6 of FIG. 1 equipped on both its faces with the antireflection multilayer.

The table below summarizes the index nᵢ and geometrical thickness eᵢ in nanometers of each of the layers:

| EXAMPLE 2 | LAYER (1) | | LAYER (2) | | LAYER (3) | | LAYER (4) | |
|---|---|---|---|---|---|---|---|---|
| nᵢ | 2.0 | | 1.46 | | 2.0 | | 1.46 | |
| eᵢ | 18 | nm | 28 | nm | 102 | nm | 90 | nm |

The purpose of this example is to minimize the value of R_{L} of the glass 6 at various angles of incidence and for which the values of R_{L} are preferably below 1%. This multilayer has the advantage of offering an absence of variation of the color in reflection according to the angle of incidence, the values of a*, b* for these same angle of incidence values being summarized, with the above characteristics, in the table below:

| Angle of incidence | R_{L} | a* | b* | Color |
|---|---|---|---|---|
| 0° | <1% | 13 | −31 | Blue |
| 20° | <1% | 15 | −30 | Blue |
| 40° | <1% | 14 | −19 | Blue |

### EXAMPLE 3

This is glass 6 of FIG. 1. The glass is a clear soda-lime-silicate glass 4 mm thick, marketed under the name of Planilux by Saint-Gobain Vitrage.

This glass is equipped on both its faces with the antireflection multilayer.

The table below summarizes the index nᵢ and geometrical thickness eᵢ in nanometers of each of the layers:

| EXAMPLE 3 | LAYER (1) | | LAYER (2) | | LAYER (3) | | LAYER (4) | |
|---|---|---|---|---|---|---|---|---|
| nᵢ | 2.0 | | 1.46 | | 2.0 | | 1.46 | |
| eᵢ | 26 | nm | 25 | nm | 76 | nm | 90 | nm |

This multilayer is particularly suited to an application as shop windows or display or sales furniture, for which the color in transmission is neutral (close to gray), the light reflection is very much below 2% and advantageously below 1%, the values of a*, b* are 27 and -27 respectively, and the color in reflection at 0° incidence is red-violet. This multilayer can undergo heat treatment; it can be toughened and curved and no optical defects occur for radii of curvature in excess of 1 m. The haze measured after curving, in the region of greatest curvature, is less than ΔH=6%.

### EXAMPLE 4

This is glass 6 of FIG. 1. The glass is a clear soda-lime-silicate glass 4 mm thick, marketed under the name of Planilux by Saint-Gobain Vitrage.

This glass is equipped on both its faces with the antireflection multilayer.

The table below summarizes the index nᵢ and geometrical thickness eᵢ in nanometers of each of the layers:

| EXAMPLE 4 | LAYER (1) | | LAYER (2) | | LAYER (3) | | LAYER (4) | |
|---|---|---|---|---|---|---|---|---|
| nᵢ | 2.0 | | 1.46 | | 2.0 | | 1.46 | |
| eᵢ | 26 | nm | 25 | nm | 76 | nm | 90 | nm |

This multilayer is particularly suited to an application as shop windows or display or sales furniture for which the color in transmission is neutral (close to gray), and the light reflection is very much below 2%.

This multilayer has the advantage of offering an absence of variation of the color (red-violet) in reflection according to the angle of incidence, the values of a*, b* for these same angle of incidence values being summarized, with the above characteristics, in the table below:

| Angle of Incidence | R_{L} | a* | b* | Color |
|---|---|---|---|---|
| 0° | <1% | 27 | −27 | Red- |
| | | | | Violet |
| 20° | <1% | 24 | −18 | Red- |
| | | | | Violet |
| 40° | 1.4% | 14 | 1 | Red |

This multilayer can undergo heat treatment; it can be toughened and curved and no optical defects occur for radii of curvature in excess of 1 m. The haze measured after curving, in the region of greatest curvature, is less than ΔH=6%.

For the multilayers covered by examples 1 to 4, based on Si₃N₄, their mechanical resistance in the TABER test is as follows (using the method already explained):

Mechanical resistance: ΔH (before toughening)<1%
ΔH (after toughening)<1%
   and their resistance to heat treatment: after toughening, no optical defects are found, the haze measured after toughening is less than ΔH=3%, and advantageously below 1%, and after curving with a radius of curvature greater than 100 cm here again no optical defects are found, and the haze measured after curving, in the region of greatest curvature, is below ΔH=6%.

### EXAMPLE 5

For this example, the antireflection multilayer used is as follows:

(6): glass

(1): SnZn₂O₄ index n1=2.05

(2): SiO₂ index n2=1.46

(3): SnZn₂O₄ index n3=2.05

(4): SiO₂ index n4=1.46

This is glass 6 of FIG. 1. The glass is a clear soda-lime-silicate glass 4 mm thick, marketed under the name of Planilux by Saint-Gobain Vitrage.

This glass constitutes a monolithic glazed unit and is equipped on both faces with the antireflection multilayer.

The table below summarizes the index nᵢ and geometrical thickness eᵢ in nanometers of each of the layers:

| EXAMPLE 5 | LAYER (1) | | LAYER (2) | | LAYER (3) | | LAYER (4) | |
|---|---|---|---|---|---|---|---|---|
| nᵢ | 2.05 | | 1.46 | | 2.05 | | 1.46 | |
| eᵢ | 20 | nm | 30 | nm | 77 | nm | 91 | nm |

This multilayer is particularly suited to an application as shop windows or display or sales furniture, for which the color in transmission is neutral (close to gray), the light reflection is very much below 2% and advantageously below 1%, the values of a*, b* are 18 and -19 respectively, and the color in reflection at 0° incidence is red-violet.

For the multilayer covered by this example 5, and based on SnZn₂O₄, the mechanical resistance in the TABER test (according to the method already described) is as follows:

Mechanical resistance: ΔH (before toughening) of the order of 3 to 4%
ΔH (after toughening) of the order of 1.5 to 2.5
   and their resistance to heat treatment: after toughening, no optical defects are found, the haze measured after toughening is less than ΔH=3%, and advantageously below 1%, and after curving with a radius of curvature greater than 10 cm here again no optical defects are found, and the haze measured after curving, in the region of greatest curvature, is below ΔH=6%.

### EXAMPLE 6

For this example, the antireflection multilayer used is as follows:

(6): glass

(1): SiTiOx index n1=2.00

(2): SiO₂ index n2=1.46

(3): SiTiOx index n3=2.00

(4): SiO₂ index n4=1.46

This is glass 6 of FIG. 1. The glass is a clear soda-lime-silicate glass 4 mm thick, marketed under the name of Planilux by Saint-Gobain Vitrage. This glass constitutes a monolithic glazed unit and is equipped on both faces with the antireflection multilayer.

The table below summarizes the index nᵢ and geometrical thickness eᵢ in nanometers of each of the layers:

| EXAMPLE 6 | LAYER (1) | | LAYER (2) | | LAYER (3) | | LAYER (4) | |
|---|---|---|---|---|---|---|---|---|
| nᵢ | 2.00 | | 1.46 | | 2.00 | | 1.46 | |
| eᵢ | 21 | nm | 28 | nm | 78 | nm | 93 | nm |

This multilayer is particularly suited to an application as shop windows or display or sales furniture, for which the color in transmission is neutral (close to gray), the light reflection is very much below 2% and advantageously below 1%, the values of a*, b* are 32 and -34 respectively, and the color in reflection at 0° incidence is red-violet.

For the multilayer covered by this example 6, and based on SiTiOx, the mechanical resistance in the TABER test (according to the method already described) is as follows:

Mechanical resistance: ΔH (before toughening) of the order of 2 to 3%
ΔH (after toughening) about 2%
   and the resistance to heat treatment: after toughening, no optical defects are found, the haze measured after toughening is less than ΔH=3%, and advantageously below 1%, and after curving with a radius of curvature greater than 10 cm here again no optical defects are found, and the haze measured after curving, in the region of greatest curvature, is below ΔH=6%.

All these examples (examples 1 to 6) are to be compared with a multilayer known from the prior art and which has the following characteristics: For this example, the antireflection multilayer used is as follows:

(6): glass

(1): TiO₂ index n1=2.45

(2): SiO₂ index n2=1.46

(3): TiO₂ index n3=2.45

(4): SiO₂ index n4=1.46

The table below summarizes the index nᵢ and geometrical thickness eᵢ in nanometers of each of the layers:

| EXAMPLE of | | | | | | | | |
|---|---|---|---|---|---|---|---|---|
| the prior art | LAYER (1) | | LAYER (2) | | LAYER (3) | | LAYER (4) | |
| nᵢ | 2.45 | | 1.46 | | 2.45 | | 1.46 | |
| eᵢ | 30 | nm | 30 | nm | 100 | nm | 100 | nm |

The light reflection is close to 0.85, and the values of a*, b* are −5.9, −1.6 respectively.

For the multilayer covered by this example known from the prior art, based on TiO₂, the mechanical resistance in the TABER test (according to the method already described) is as follows:

Mechanical resistance: ΔH (before toughening) 4.5%
ΔH (after toughening) 5%
   and the resistance to heat treatment: after toughening, a few optical defects are found, and after curving with a radius of curvature in excess of 100 cm here again numerous optical defects are found, and the haze measured after curving, in the region of greatest curvature, is ΔH equal to 38%.

Examples 1 to 6 can also be compared with an alternative form of the multilayer in which the thickness of the fourth layer has been increased to 70 nm.

Glass/SnZn₂O₄/SiO₂/SnZn₂O₄/SiO₂

| Alternative form | | | | |
|---|---|---|---|---|
| of multilayer A | Layer 1 | Layer 2 | Layer 3 | Layer 4 |
| ni | 2.05 | 1.46 | 2.05 | 1.46 |
| ei | 20 | 30 | 77 | 70 |

Optical: R_{L} = 4.2%; a* = 6; b* = 26
Mechanical resistance: ΔH (before toughening) = 3-4%; ΔH (after toughening) = 1.5-2.5%

Resistance to heat treatment: toughening: no defects; curving for R≧10 cm: no defects

It can therefore be seen that the color is not optimized (it tends toward yellow, yellowish) and the light reflection is not improved.

1. A transparent substrate (6), comprising on at least one of its faces an antireflection coating, particularly at normal incidence made of a multilayer (A) of thin layers made of dielectrical material with alternatively high and low refractive indexes, characterized in that the multilayer comprises, in succession:
a high-index first layer (1), with a refractive index n₁ of between 1.8 and 2.2 and geometrical thickness e₁ of between 5 and 50 nm,
a low-index second layer (2), with a refractive index n₂ of between 1.35 and 1.65 and a geometrical thickness e₂ of between 5 and 50 nm,
a high-index third layer (3) with a refractive index n₃ of between 1.8 and 2.2 and a geometrical thickness e₃ of between 40 and 150 nm,
a low-index depth fourth layer (4) with a refractive index n₄ of between 1.35 and 1.65 and a geometrical thickness e₄ of between 40 and 120 nm.

2. The substrate (6) as claimed in claim 1, wherein n₁ and/or n₃ are between 1.85 and 2.15, particularly between 1.90 and 2.10.

3. The substrate (6) as claimed in claim 1, wherein n₂ and/or n₄ are between 1.35 and 1.65.

4. The substrate (6) as claimed in claim 1, wherein e₁ is between 5 and 50 nm, particularly between 10 and 30 nm or between 15 and 25 nm.

5. The substrate (6) as claimed in claim 1, wherein e₂ is between 5 and 50 nm, particularly less than or equal to 35 nm or to 30 nm, particularly being between 10 and 35 nm.

6. The substrate (6) as claimed in claim 1, wherein e₃ is between 45 and 80 nm.

7. The substrate (6) as claimed in claim 1, wherein e₄ is between 45 and 110 nm and preferably between 70 and 100 nm.

8. A substrate (6) as claimed in claim 1 wherein the high-index first layer (1) and the low-index second layer (2) are replaced by an intermediate-index single layer (5) e₅ of between 1.65 and 1.80 and preferably having an optical thickness e_{.pot5} of between 50 and 140 nm, preferably between 85 and 120 nm.

9. The substrate (6) as claimed in claim 8, wherein the intermediate-index layer (5) is based on a mixture of, on the one had, silicon oxide and, on the other hand, at least one metal oxide chosen from tin oxide, zinc oxide, titanium oxide or is based on a silicon oxynitiride or oxycarbide and/or aluminum oxynitride.

10. The substrate (6) as claimed in claim 1, wherein the high-index first layer (1) and/or the high-index third layer (3) are based on metal oxide(s) chosen from zinc oxide, tin oxide, zirconium oxide or based on (a) nitride(s) chosen from silicon nitride and/or aluminum nitride or based on mixed tin/zinc oxides (SnxZnyOz) or mixed zinc-titanium oxides (TiZnOₓ) or based on mixed silicon-titanium oxide (SixTiyOz).

11. The substrate (6) as claimed in claim 1, wherein the high-index first layer(1) and/or the high-index third layer (3) consist of a superposition of several high-index layers, particularly of a superposition of two layers such as SnO₂/Si₃N₄ or Si₃N₄/SnO₂.

12. The substrate (6) as claimed in claim 1, wherein the low-index second layer (2) and/or the low-index fourth layer (4) are based on silicon oxide, silicon oxynitride and/or oxycarbide or on a mixed oxide of silicon and of aluminum.

13. The substrate (6) as claimed in claim 1, wherein said substrate is made of clear or bulk-tinted glass.

14. The substrate as claimed in claim 1, wherein its light reflection on the side on which it is equipped with the multilayer made up of thin layers is lowered by a minimum amount of 3 or 4% at a normal angle of incidence.

15. The substrate as claimed in claim 1, wherein the colorimetry of its light reflection on the side on which it is equipped with the multilayer made up of thin layers is such that the corresponding b* value in the (L*, a*, b*) colorimetry system is negative, at a normal angle of incidence.

16. The substrate as claimed in claim 1, wherein the antireflection multilayer uses, at least for its high-index third layer, a mixed tin/zinc or silicon titanium oxide, a silicon nitride, so that it is able to undergo a heat treatment of the curving, toughening, annealing type and so that it has enhanced mechanical and chemical durability.

17. The substrate as claimed in claim 16, wherein the antireflection multilayer uses, at least for its high-index third layer, a silicon nitiride so that it has very good mechanical durability such that ΔH in the TABER test is less than 3%.

18. The substrate as claimed in claim 16, wherein the antireflection multilayer uses, at least for its high-index third layer, a mixed tin/zinc or silicon titanium oxide so that it is able to undergo significant heat treatment, particularly curving, bending, of great severity, it being possible for R to reach 10 cm.

19. The substrate (6) as claimed in claim 1, wherein it is equipped on one of its faces with the anti-reflection multilayer and, on its other face, either with no antireflection multilayer or also with an antireflection multilayer, or with another type of antireflection coating, or with a coating having some other functionality of the solar protection, low emissivity, antifouling, antifogging, antirain or heating type.

20. The substrate as claimed in claim 19, wherein the other type of antireflection coating is chosen from the following coatings:
a single layer with a low index, lower than 1.60 or 1.50, particularly of about 1.35-1.48, particularly based on silicon oxide,
a single layer the refractive index of which varies through its thickness, particularly of the silicon oxynitride SiOₓN_{y}, type, with x and y varying through its thickness,
a two-layer multilayer comprising, in succession, a layer with a high index of at least 1.8, particularly tin oxide, zinc oxide, zirconium oxide, titanium oxide, silicon or aluminum nitride, followed by a layer with a low index, below 1.65, particularly made of silicon oxide, oxynitride or oxycarbide,
three-layer multilayer comprising, in succession, a layer of medium index of between 1.65 and 1.8 of the silicon and/or aluminum oxycarbide or oxynitride type, a layer with a high index above 1.9 of the SnO₂, TiO₂ type, a layer with a low index less than 1.65 of the mixed Si—Al oxide or silicon oxide type antifouling coating.

21. A multiple glazed unit, particularly a double glazed unit, or unit with a laminated structure, comprising at least two substrates as claimed in claim 1, wherein the two glass substrates (6, 6′) are combined using a sheet (7) of thermoplastic, the substrate (6) being equipped, on the opposite side to the assembly, with the antireflection multilayer and the substrate (6′) being equipped, on the opposite side to the assembly, with either no antireflection coating or also an antireflection coating, or with another type of antireflection coating, or with a coating having another functionality of the solar protection, low emissivity, antifouling, antifogging, antirain or heating type, it also being possible for said coating with another functionality to be located on one of the faces of the substrates that face toward the thermoplastic sheet used for assembly.

22. A method for obtaining producing the glazing as claimed in claim 21, comprising depositing the antireflection multilayer or multilayers is or are deposited by cathode sputtering and optionally depositing an antireflection coating by a sol-gel technique, a pyrolysis technique of the CVD, or plasma CVD type, by cathode sputtering or by corona discharge.

23. A glazed product produced by the glazing method as claimed in claim 21 wherein said glazed product is an interior or exterior glazing for buildings, a display cabinet, a counter in stores, that may be curved, an anti-dazzle computer screen, or a glass furniture.
